(19) United States
(12) Patent Application Publication
(10) Pub. No.: US 2011/0170104 A1
(43) Pub. Date: Jul. 14, 2011

(54) METHOD FOR MEASURING THE SPECTRAL PHASE OF A PERIODIC SIGNAL

(75) Inventors: Christophe Gosset, Perros Guirec (FR); Jérémie Renaudier, Gif-sur-Yvette (FR); Jean-Louis Oudar, Chatenay Malabry (FR); Guy Georgea Aubin, Viroflay (FR)

(73) Assignee: Centre National De La Recherche Scientifique-CNRS, Paris Cedex 16 (FR)

(21) Appl. No.: 12/529,899

(22) PCT Filed: Mar. 4, 2008
(86) PCT No.: PCT/FR2008/000283

§ 371 Date: Jan. 21, 2010

(30) Foreign Application Priority Data
Mar. 5, 2007 (FR) 07/01588

(51) Int. Cl. G01J 9/04

(52) U.S. Cl. 356/450

(57) ABSTRACT

The invention relates to a self-referenced device (1) for measuring the spectral phase of a periodic signal having a frequency fₚ, the periodic signal being carried by an optical signal, comprising: a phase shifting means (4); a transmission means (3) for transmitting at least three optical modes of said periodic signal to the phase shifting means, said optical modes defining beats at the fₚ frequency; the phase shifting means (4) being capable of modifying the phase difference between the beats at the fₚ frequency; characterised in that the measuring means (6, 7, 8) include: photoelectric conversion means (6) for detecting the variable term at the fₚ frequency of the optical signal received power in order to generate an electric signal (14) corresponding to the superimposition of the optical beats at the fₚ frequency; electric measuring means (7, 8) for measuring the amplitude of the electric signal in order to determine the amplitude of the beats at the fₚ frequency.

The invention relates to a device for measuring the spectral phase of a periodic signal at a frequency fₚ, the periodic signal being carried by an optical signal.

A signal resulting from the modulation of a carrier optical signal by a time t—dependant envelope can be expressed as follows:

E(t)=Re(a(t) exp (2iπf₀t)), wherein A(t) is the complex envelope of the optical signal, as fₒ is the optical reference of the carrier and the letters Re( ) designate the real part of a complex function.

The invention aims at determining the spectral phase of the function A(t) when A(t) is periodic.

When the function A(t) is a periodic function having the frequency fₚ, it can be expressed as follows:

A(t)=SUM(1, M, Pk^{1/2} exp [i (2(k−1)πfₚt+φₖ])

wherein
SUM (i, j, f(k)) is the sum for k between i and j of the f(k);
Pₖ is the power of the k^{th} optical mode of the signal A(t);
φₖ is the phase of the k^{th} optical mode of the signal A(t);

The spectral phase of A(t) corresponds to all the phases φₖ of the optical modes thereof.

Several devices have been provided for measuring such spectral phase.

Several of these devices use a reference clock synchronised with the periodic signal to determine a measure of the spectral phase.

However, the utilisation of such a synchronised reference clock is not advantageous, more particularly because of the cost of adaptation of such a clock for various emitting devices. The disadvantage of the clock recovery devices is the additional costs they entail.

Contrarily to the devices requiring a reference clock, the invention relates a self-referenced device for measuring a spectral phase.

In the field of such self-referenced devices and more particularly from the work by Gosset and al. “Phase and amplitude characterization of a 40-Ghz self pulsating DBR laser based on autocorrelation analysis”, Journal of Lightwave Technology, Vol 24, N^{o}2, 2006, is known a device for measuring the spectral phase of a periodic signal at a frequency fₚ, the periodic signal being carried by an optical signal including:
phase shifting means;
transmission means arranged for transmitting at least three optical modes of said periodic signal to the phase shifting means with said optical modes defining beats with the frequency fₚ;
the phase shifting means being arranged for modifying the phase difference between the beats at the frequency fₚ;
measuring means arranged for measuring the amplitude of the beats at the frequency fₚ.

In the above-mentioned work, it was shown that, for a selection of three and four optical modes, it is possible to determine the relative phase of these optical modes. The selection of at least three adjacent optical modes makes it possible to define beats at the frequency fₚ. When a phase shift is introduced between the beats with the frequency fₚ, the amplitude of the resulting beats with the frequency fₚ varies. In the case of a three mode signal, this variation is sinusoidal. A measure of the amplitude of the beats then makes it possible to determine the spectral phase of the three mode signals.

In the above-mentioned work, the measuring means used for measuring the amplitude of the beats includes an intensity auto-correlator based on the generation of a second optical harmonic followed by a Fourier analysis of the signal supplied by the auto-correlator.

However, such an auto-correlator has a low sensitivity so that it is necessary to use an optical amplifier to amplify the optical signal filtered at the output of the phase shifting means. In addition, as the phenomenon of the generation of the second harmonic is sensitive to the polarisation of the optical signal, it is necessary to use a polarisation monitor at the entrance of auto-correlator.

The invention, more particularly aims at remedying such drawbacks.

The problems solved by the invention consist more particularly in providing a device as previously described with a better sensitivity.

The problem is solved by a self-referenced device as previously described, wherein the measuring means includes photoelectric conversion means arranged for detecting the variable term with the frequency fₚ of the optical signal received power so as to generate an electric signal corresponding to the superimposition of the optical beats with the frequency fₚ, in order to generate an electric signal corresponding to the superimposition of the optical beats with the frequency fₚ, and electric measuring means arranged for measuring the amplitude of the electric signal, so as to determine the amplitude of the optical beats with the frequency fₚ.

The idea on which the invention is based is thus having realised that the detection of the variable term at the frequency fₚ would enable an improvement of the device sensitivity.

Thanks to such photoelectric conversion means, the optical beats at the frequency fₚ are converted into an electric signal and this electric signal is measured by measuring electric means which improve the sensitivity of the measurement of the amplitude. As a matter of fact, in the state of the prior art, the utilisation of an auto-correlator enables to measure only signals the power of which is greater than a typical value of the order of 1 mW. Thanks to the direct conversion of the optical signal into an electric signal, the sensitivity can be improved by at least a coefficient 100, in the present state of the art of the detection of electric signals, and thus optical signals, the power of which does not exceed 10 μW, can be measured.

In the above-mentioned work, a photodiode is used for transforming an optical signal into an electric signal prior to the passage through an oscilloscope and a Fourier analysis. However, such a photodiode is a so-called slow photodiode which means that, for the detection of a signal having a power of the P(t)=P0+P₁ cos ((2πfₚ)·t+φ) type, the photodiode can detect only the constant P₀ and not the variable term at the frequency fₚ, P₁ cos ((2πfₚ)·t+φ). The above-mentioned work thus does not teach a self-referenced device including photoelectric conversion means arranged for detecting the variable term at the frequency fₚ of the optical signal received power as in the invention.

On the contrary, according to the invention a self-referenced device includes such photoelectric conversion means arranged for detecting the variable term at the frequency fₚ of the optical signal received power, for example in the form of a so-called fast photodiode which can detect this variable term at the frequency fₚ.

Fast photodiodes used for detecting a variable term at the frequency fₚ are known for example from document by Kockaert and al. “Simple amplitude and phase measuring technique for ultra-high-repetition-rate lasers”. However, in this document, the term detected is directly resulting from two adjacent modes without the introduction of a phase shift as in the invention. Then, the device described in such document is a referenced device which requires a clock signal. As regards this document, the invention enables to remedy the drawback of using a reference clock. In addition, this document does not mention the problem of improving the sensitivity with respect to autocorrelation systems.

Advantageous embodiments of the invention will now be described.

According to a first embodiment, the conversion means includes a photodiode having a bandwidth, the frequency fₚ being within the bandwidth.

According to this embodiment, since the frequency fₚ is within the bandwidth of the photodiode, the photodiode can detect the beats at the frequency fₚ.

This embodiment has an advantage in that it is possible to use photodiodes very little sensitive to the polarisation of the detected signals.

According to another embodiment the invention, the conversion means includes:
frequency modification means arranged for modifying the beats for the frequency fₚ into beats at a second frequency fₚ′ different from the frequency fₚ without modifying the phase of the beats;
a photodiode having a bandwidth, the second frequency fₚ′ being within the bandwidth of the photodiode.

This embodiment has an advantage in that it makes it possible to use photodiode having a bandwidth which can be not so high as the frequency fₚ of the periodic signal while enabling to measure the amplitude, thanks to a conversion adapted to the bandwidth of the photodiode, when the second frequency fₚ′ is lower than the frequency fₚ of the periodic signal.

According to the invention, the phase shifting means includes optical fibres having different lengths. This is only an exemplary embodiment. Other phase shifting means are possible: frequency shift Bragg networks, diffraction networks, etc.

The propagation in optical fibres having different lengths makes it possible to modify the phase difference between the beats to the frequency fₚ.

According to the invention, the transmission means include a filter the wavelength of which can preferably be tuned. The bandwidth of the server is adapted for selecting at least three optical modes.

The advantage entailed therein is that it enables a simple selection of the various groups of at least three optical modes of the periodic signal. By successively analysing all the groups of at least three adjacent modes, it is possible to have a complete light on the spectral phase of the periodic signal for all the optical modes.

An embodiment of the invention will now be described while referring to the appended drawings wherein:

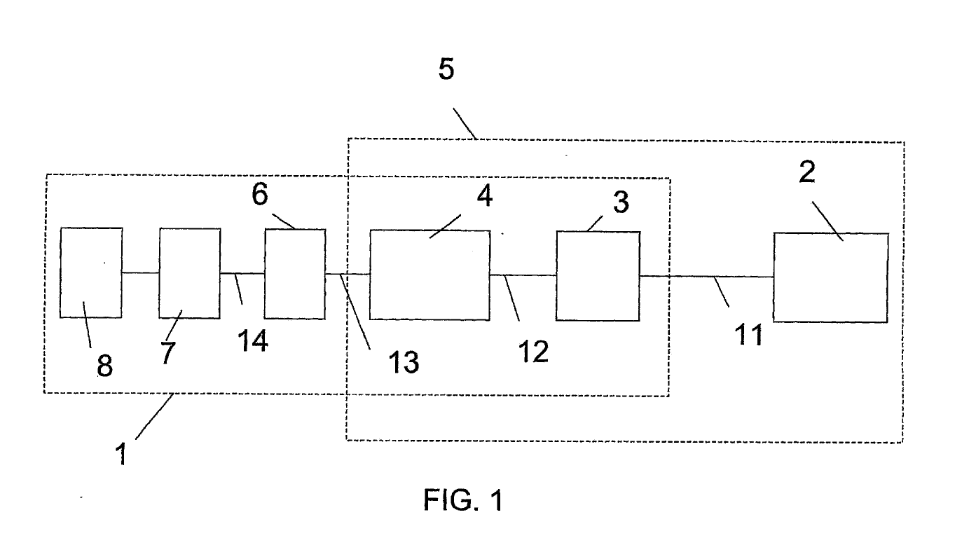

FIG. 1 is a diagram illustrating a device according to one embodiment of the invention;

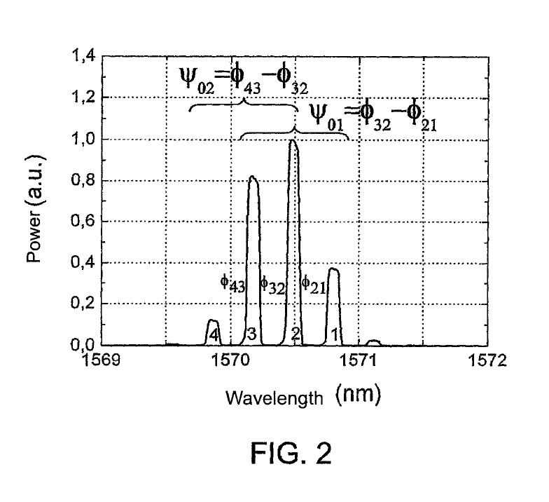

FIG. 2 illustrates an optical spectrum of the periodic signal in an intensity diagram as a function of the wavelength;

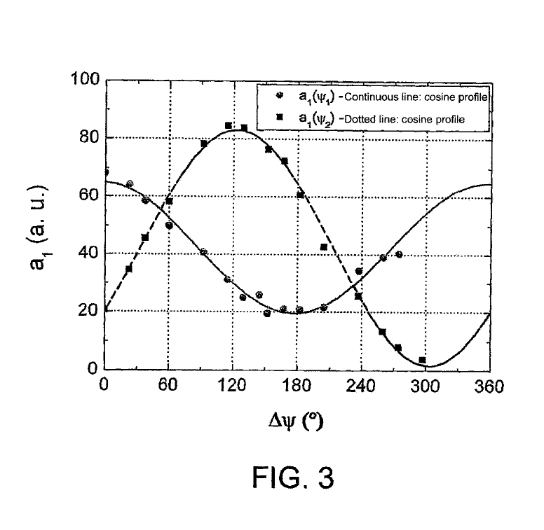

FIG. 3 illustrates the evolution of the amplitude of the beats at frequency fₚ for a group of three adjacent optical modes obtained according to the invention as a function of the phase shift introduced between two optical beats at the frequency fₚ.

Is illustrated in FIG. 1 a device 1 for measuring a spectral phase of a periodic signal 11 at a frequency fₚ carried by an optical signal. The signal 11 is generated by a laser 2 of the DBR (Distributed Bragg Reflector) type which means distributed Bragg reflector mirror. The laser 2 pulse operating condition (mode locking), is a pulse laser emitting a radiofrequency periodic signal carried by an optical signal. The radiofrequency periodic signal has a frequency of 40 Ghz. This is only an exemplary embodiment of an optical periodic signal.

Such a signal resulting from the modulation of a carrier optical wave by a time t—dependant envelope can be expressed as follows:

E(t)=Re(A(t) exp (2iπf₀t)), wherein A(t) is the complex envelope of the optical signal, f₀ is the optical frequency of the carrier and the letters Re( )designate the real part of a complex function.

The device 1 is arranged to determine the spectral phase of the function A(t), when A(t) is a periodic function at the frequency fₚ, i.e. when A(t) can be expressed as follows:

A(t)=SUM (1, M, Pₖ^{1/2} exp [i(2(k−1)πfₚt+φₖ])

wherein
SUM (i, j, f(k)) is the sum for k between i and j of f(k);
Pₖ is the power of the k^{th} optical mode of the optical signal E(t);
φₖ is the phase of the k^{th} optical mode of the optical signal E(t);

The spectral phase of A(t) corresponds to the phases φₖ of such modes.

The device 1 includes a filter 3 arranged for receiving the signal 11. The filter 3 is adapted for selecting three adjacent optical modes k1, k2 and k3 of the signal 11 represented by E(t). The filter 3 has a bandwidth of 1 nanometre so as to be adapted to the frequency fₚ of 40 Ghz.

At the filter outlet, an optical signal 12 including the three optical modes k1, k2, and k3 is thus generated. The optical modes k1, k2 and k3 are shown in FIG. 2 in a power diagram as a function of the wavelength.

This signal is supplied at the phase shifting device 4 inlet. The phase shifting device 4 is arranged for introducing a known phase shifting at the relative phase of the beats defined by two modes.

Two adjacent optical modes define, in a way known per se, a beat at the frequency fₚ having a phase φ equal to the difference in the phases of the two modes defining the beat. Three adjacent optical modes define two optical beats at the frequency fₚ and one optical beat at the frequency 2fₚ. The phase difference between the two beats at the frequency fₚ is mentioned ψ.

This phase difference is defined, in a way known per se, as follows:

Let φ1, φ2 and φ3 be the respective phases of the optical modes k1, k2 and k3 in FIG. 2, the first beat at the frequency fₚ being defined by the optical modes k1 and k2 has a phase equal to φ₂₁=φ₂−φ₁, and the second beat of the frequency fₚ defined by the optical modes k2 and k3 at a phase equal to φ₃₂=φ₃−φ₂. The relative phase of the beats is thus equal to ψ=φ₃₂−φ₂₁. It should be noted that this relative phase of the beats is equal to a phase of the second order as a function of the phases of the normal modes ψ=φ₃−2φ₂+φ₁.

The phase shifting device 4 is then arranged to add a known phase Δψ to the phase difference ψ between the beats of the frequency fₚ.

The phase shifting device 4 includes for example dispersive optical fibres having different lengths so as to introduce a known phase shifting proportional to the length of the optical fibres.

Generally speaking, the assembly 5 composed of the laser 2, the filter 3 and the phase shifting device 4 can be selected as in the above-mentioned work “Phase and amplitude characterisation of a 40-Ghz self pulsating DBR laser based on auto-correlation analysis”.

At the outlet of the assembly 5, the signal 13 formed by the three optical modes has an amplitude as follows:

P(t)=P₀+P₂₁ cos ((2πFₚ)·t+φ₂₁)+(P₃₂ cos ((2πfₚ)·t+φ₃₂)+P₃₁ cos ((4fₚ)·t+φ₃₁)

wherein the cosine terms (2π fₚ)·t correspond to the beats at the frequency fₚ on the one hand, between the modes k1 and k2, and on the other hand, between the modes k2 and k3, and the cosine term(4π fₚ)·t corresponds to a beat at the frequency 2fₚ between the modes k1 and k3. In the above formula, the terms φ₂₁, φ₃₂ and φ₃₁ correspond to the phases of the phase shifted beats by the phase shifting device 4, so that (φ₃₂−φ₂₁)−(φ₃₂−φ₂₁)=Δψ.

The device 1 further includes a photodiode 6 having a bandwidth at least equal to the frequency fₚ so as to be able to detect the beats at the frequency fₚ defined by at least two adjacent optical modes.

The photodiode 6 is thus capable of detecting the term P₂₁ cos ((2π fₚ)·t+φ21′)+P₃₂ cos ((2π fₚ)·t+φ₃₂′) in the expression of the power mentioned above. Such a photodiode is known per se as a “fast photodiode” as opposed to a “slow photodiode” which would be able to detect only the constant term P₀. Fast photodiodes having a bandwidth B are components making it possible to detect optical signals, the radiofrequency of which is lower than B. On the contrary, slow detectors are sensitive to average power only.

At the outlet of the photodiode 6, a signal 14 is thus obtained which has a profile of amplitude having the shape of a sinusoid in time and the amplitude of which depends on Δψ as illustrated in FIG. 3.

The evolution of the amplitude of this signal with a phase shifting Δψ is of the A+Bcos(φ+Δψ) type as this is possible by measuring the amplitude of the beat for at least one phase shifting 4 to determine by an adjustment the value of the phase shifting ψ between the two beats at the frequency fₚ.

In order to measure the amplitude of the electric signal resulting from the beat at the frequency fₚ, the device 1 more particularly includes a rectifier 7 intended to provide a continuous signal, the value of which depends on the amplitude of the frequency fₚ of the signal 14 and connected to the power meter or voltmeter 8 or any other means.

When the value of the phase shifting between the two beats of the frequency fₚ is obtained, the phases of each optical mode is obtained thanks to the following formula:

φₖ (t)=SUM(j=1, j=m−1, SUM (k=1, k=J−1

φₖ is the phase difference between two beats corresponding to the adjacent optical modes with ch_{φ}ₖ=φₖ₊₁−2φₖ+φₖ₋₁.

In a self-referenced measure, the phases of the first two optical modes corresponding to m=0 and m=1 are arbitrary. Others can be selected but always in the number of two. As a matter of fact, the variation in the phase φ₀ is equivalent to a variation in the phase of the optical carrier, and a variation in the difference φ₁−φ₀ is equivalent to a phase variation of the periodic signal which means that the moment of the time of appearance in the periodic signal is changed, which does not change the time profile of the instant power of the periodic optic signal.

In order to obtain the values Oₖ of the phase shifting between two adjacent beats at the frequency fₚ, corresponding to three adjacent optical modes, for the whole groups of three optical modes contained in the periodic signal, the filtering zone of the filter 3 is varied. This filter 3 is thus preferably a filter the wavelength of which cannot be tuned so that the filter has not to be changed upon each selection of a group of three optical modes.

Knowing all the phase differences between the beat corresponding to adjacent optical modes make it possible to obtain a complete knowledge of the profile of amplitude in signal phase emitted by the laser 2, since this profile can be calculated from the knowledge of the optical spectrum and the phase differences between adjacent beats ψₖ. This is shown in detail in the above mentioned work “Phase and amplitude characterization of a 40-Ghz self pulsating DBR laser based on autocorrelation analysis”.

Alternative solutions of the invention will now be described.

An embodiment wherein the filter 3 is arranged for exactly selecting three optical modes of the periodic signal generated by the laser 2 has been described. The selection of three optical modes gives a satisfactory accuracy in the measurement of the spectral phase. However, when reducing this precision, it is possible to use filters selecting more than three optical modes of the periodic signal. The precision of the measurement is reduced when the number of selected optical modes increases.

In addition, if the spectral phase of three particular optical modes is the only phase of interest, it is not necessary to select several groups of three optical modes so that the wavelengthof the filter 3 cannot necessarily be tuned. Similarly, if the laser 2 directly generates only three optical modes, the filter 3 is not necessary and the introduction of the phase shifting can be carried out directly at the outlet of the laser 2.

In addition, an embodiment wherein photodiode 6 is a fast photodiode having the bandwidth greater than the frequency fₚ of the periodic signal has been described.

However, it is also possible to replace such a fast photodiode 6 by another photodiode able of detecting the beats of the frequency fₚ′ lower than fₚ. In this case, means for modifying the frequency of the beats are positioned before such a photodiode so as to draw back such beats to the frequency fₚ′ so that it can be detected by the photodiode.

These frequency modification means include for example a modulator which sinusoidally modulates the signal the frequency of which must be translated. This result is a property of the Fourier transform and is known in the field of signal processing.

1. A self-referenced device (1) for measuring the spectral phase of a periodic signal having a frequency fₚ, the periodic signal being carried by an optical signal comprising:
a phase of shifting means (4);
a transmission means (3) arranged for transmitting at least three optical modes of said periodic signal to the phase shifting means, said optical modes defining beats at the frequency fₚ;
the phase shifting means (4) being capable of modifying the phase difference between the beats at the frequency fₚ;
measuring means (6, 7, 8) arranged for measuring the amplitude of the beats at the frequency fₚ;
characterised in that the measuring means (6, 7, 8) include:
photoelectric conversion means (6) arranged for detecting a variable term at the frequency fₚ of the optical signal received power in order to generate an electric signal (14) corresponding to the superimposition of the optical beats at the frequency fₚ;
electric measuring means (7,8) arranged for measuring the amplitude of the electric signal in order to determine the amplitude of the beats and the frequency fₚ.

2. A device according to claim 1, wherein the photoelectric conversion means includes a photodiode having a bandwidth, with the frequency fp being in the bandwidth of the photodiode.

3. A device according to claim 1, wherein the photoelectric conversion means includes:
frequency modification means arranged for transposing the frequency of the beats at the frequency fₚ into beats at a second frequency fₚ′ different from the frequency fₚ without modifying the phase of the beats;
a photodiode having a bandwidth, the second frequency fₚ′ being the bandwidth of the photodiode.

4. A device according to claim 3, wherein the second frequency fₚ′ is lower than the frequency fₚ.

5. A device according to claim 1, 2, 3, or 4, wherein the phase shifting means includes optical fibres having different lengths.

6. A device according to claim 1, 2, 3, or 4, wherein the transmission means includes a filter having a bandwidth arranged for isolating said at least three optical modes in the periodic signal.

7. A device according to claim 6, wherein the wavelength of said filter can be tuned.

8. A device according to claim 6, wherein the filter is arranged for isolating three optical modes in the periodic signal.

9. A device according to claim 7, wherein the filter is arranged for isolating three optical modes in the periodic signal.
